(19) United States
(12) Patent Application Publication
(10) Pub. No.: US 2017/0305405 A1
(43) Pub. Date: Oct. 26, 2017

(54) METHOD AND APPARATUS FOR TRANSMISSION GEAR SELECTION IN A PARALLEL-HYBRID POWERTRAIN SYSTEM

(71) Applicant: GM GLOBAL TECHNOLOGY OPERATIONS LLC, Detroit, MI (US)

(72) Inventors: Min-Joong Kim, Troy, MI (US); Norman K. Bucknor, Troy, MI (US)

(73) Assignee: GM GLOBAL TECHNOLOGY OPERATIONS LLC, Detroit, MI (US)

(21) Appl. No.: 15/136,115

(22) Filed: Apr. 22, 2016

(51) Int. Cl. B60W 20/10; B60W 10/04; B60W 10/06; B60K 6/48; B60W 10/10; B60W 10/101; B60W 10/11; B60K 6/54; B60W 10/08

(52) U.S. Cl. CPC B60W 20/10; B60K 6/54; B60W 10/04; B60W 10/06; B60W 10/08; B60W 10/10; B60W 10/101; B60W 10/11; B60K 6/48; B60W 2540/10; B60W 2520/10; B60W 2710/0666; B60W 2710/0677; B60W 2710/086; B60W 2710/09; B60W 2710/1005; B60W 2710/1061; B60Y 2200/92; Y10S 903/93; B60Y 2300/188

(57) ABSTRACT

A hybrid powertrain system includes an internal combustion engine and a transmission arranged in a parallel configuration with a non-combustion torque machine to transfer traction power to a driveline. A method of controlling the hybrid powertrain system includes monitoring vehicle speed and an accelerator pedal position and determining a traction power command based thereon. A motor power that is input to the driveline from the torque machine is determined, and an adjusted engine power command is determined based upon the traction power command and the motor power from the torque machine. An adjusted accelerator pedal position is determined based upon the adjusted engine power command and the vehicle speed, and a preferred transmission state is determined based upon the adjusted accelerator pedal position and the vehicle speed. The transmission is controlled to the preferred transmission state.

### TECHNICAL FIELD

This disclosure relates to hybrid powertrain systems, and transmission gear selection related thereto.

### BACKGROUND

Hybrid powertrain systems may employ internal combustion engines and transmissions that are arranged in a parallel configuration with a torque machine to generate traction power for vehicle propulsion. Selection of a preferred gear range for operating the transmission may be affected by power output from the torque machine.

### SUMMARY

A hybrid powertrain system is described, and includes an internal combustion engine and a transmission arranged in a parallel configuration with a non-combustion torque machine to transfer traction power to a driveline of a vehicle. A method of controlling the hybrid powertrain system includes monitoring vehicle speed and an accelerator pedal position and determining a traction power command based thereon. A motor power that is input to the driveline from the torque machine is determined, and an adjusted engine power command is determined based upon the traction power command and the motor power from the torque machine is determined. An adjusted accelerator pedal position is determined based upon the adjusted engine power command and the vehicle speed, and a preferred transmission state is determined based upon the adjusted accelerator pedal position and the vehicle speed. The transmission is controlled to the preferred transmission state.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically shows a vehicle including a parallel-hybrid powertrain system coupled to a driveline and controlled by a control system, in accordance with the disclosure;

FIG. 2 schematically shows a control routine for controlling an embodiment of the powertrain system described with reference to FIG. 1 to determine a preferred transmission gear, in accordance with the disclosure;

FIG. 3-1 graphically shows one embodiment of a pedal map that includes initial engine power output values plotted in relation to vehicle speed and accelerator pedal position when all of the traction power is originating from the engine, in accordance with the disclosure;

FIG. 3-2 graphically shows one embodiment of a portion of an inverse pedal map that includes a plurality of accelerator pedal position values plotted in relation to vehicle speed and engine power output, in accordance with the disclosure; and

FIG. 3-3 graphically shows one embodiment of a transmission shift map that includes a plurality of accelerator pedal position values in relation to vehicle speed, in accordance with the disclosure.

### DETAILED DESCRIPTION

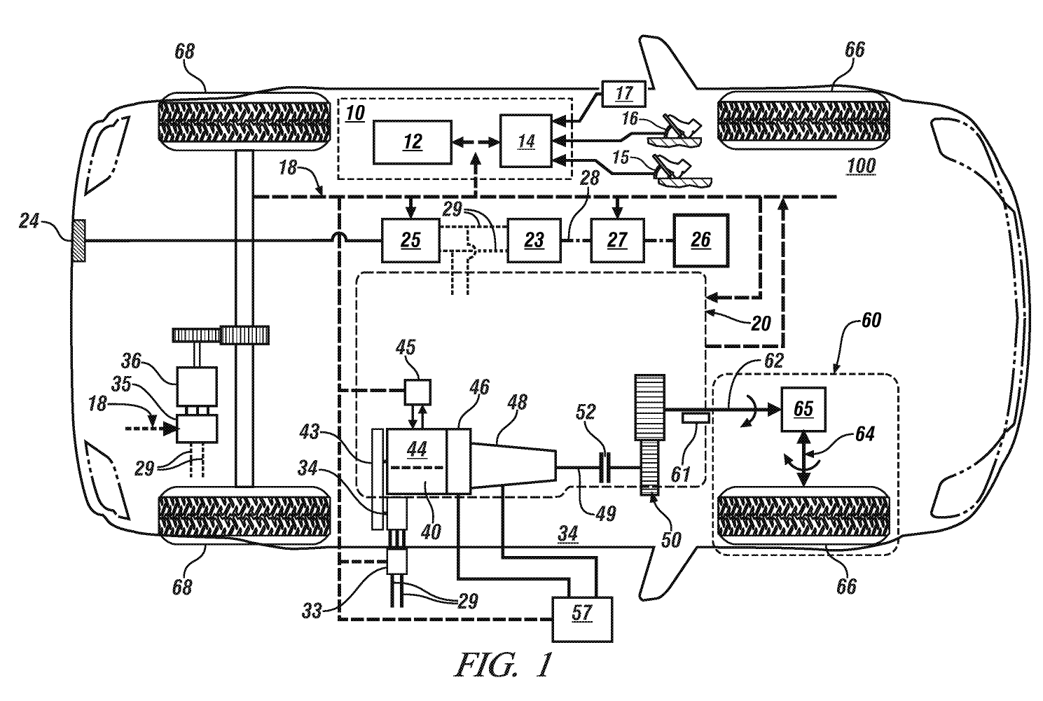

Referring now to the drawings, wherein the showings are for the purpose of illustrating certain exemplary embodiments only and not for the purpose of limiting the same, FIG. 1 schematically shows a vehicle 100 including a parallel-hybrid powertrain system 20 coupled to a driveline 60 and controlled by a control system 10. Like numerals refer to like elements throughout the description. The powertrain system 20 includes multiple torque-generating devices, including an internal combustion engine (engine) 40, a first non-combustion torque machine 36, and, in one embodiment, a second non-combustion torque machine 34 that are arranged in a parallel configuration to transfer torque to first drive wheels 66 via the driveline 60 and to second drive wheels 68 via a second configuration. The first drive wheels 66 may include front vehicle wheels and the second drive wheels 68 may include rear vehicle wheels in one embodiment.

The embodiment of the powertrain system 20 shown with reference to FIG. 1 includes a crankshaft 44 of the engine 40 that is rotatably coupled to a transmission 48 on a first end. In one embodiment, a second end of the crankshaft 44 may be rotatably coupled to the second torque machine 34 via a suitable geared mechanism 43, which may be a chain, belt, or a meshed gear. An output member 49 of the transmission 48 is couplable via activation of a controllable clutch 52 to a rotating member of a gear train 50 that includes at least two meshingly engaged gears. An output member 62 of the gear train 50 rotatably couples to the driveline 60. In one embodiment, the first torque machine 36 is coupled via a second gear train and an axle to the second to the second drive wheels 68. Alternatively, the second torque machine 34 may rotatably coupled to an input member of the transmission 48. Alternatively, the second torque machine 34 may rotatably coupled to an intermediate member of the transmission 48.

The internal combustion engine 40 and the second torque machine 34 couple to the gear train 50 and are controllable to generate traction power that may be described in terms of an output torque and a rotational speed. The traction power is transferred to the driveline 60 to propel the vehicle 100. Other embodiments of a powertrain system that include an internal combustion engine arranged in parallel with at least one torque machine to generate traction power may be employed within the scope of this disclosure. By way of definition, ‘output torque’ refers to both positive (tractive) torque and negative (braking) torque, both which can be generated by the powertrain system 20 and transferred to the output member 62. The vehicle 100 may include, by way of non-limiting examples, a passenger vehicle, a light-duty or heavy-duty truck, a utility vehicle, an agricultural vehicle, an industrial/warehouse vehicle, or a recreational off-road vehicle.

The powertrain system 20 includes the internal combustion engine 40, the first torque machine 36 and the second torque machine 34 generate output torque that is transferred via the driveline 60 to the first drive wheels 66 and to the second drive wheels 68 to generate propulsion torque. The crankshaft 44 of the internal combustion engine 40 couples via a torque converter 46 to the transmission 48, and its output member 49 rotatably couples to a gear of the gear train 50. The gear train 50 may be any suitable geared mechanism.

The engine 40 is preferably a multi-cylinder internal combustion engine that converts fuel to mechanical torque through a thermodynamic combustion process. The engine 40 is equipped with a plurality of actuators and sensing devices for monitoring operation and delivering fuel to form in-cylinder combustion charges that generate an expansion force that is transferred via pistons and connecting rods to the crankshaft 44 to produce torque. Operation of the engine 40 is controlled by an engine controller (ECM) 45.

The transmission 48 may be any suitable transmission device for transferring torque between a torque-generating device, e.g., engine 40, and the output member 49. The transmission 48 may be commanded to one of a plurality of gear ranges, including, e.g., Park, Reverse, Neutral and Drive. In one embodiment, the transmission 40 is a multi-step gear transmission that includes a plurality of meshable gears and selectively activatable clutches that are configured to transfer torque generated by the internal combustion engine 40 to the output member 49 in one of a plurality of fixed gear ratios. The fixed gear ratios may be automatically selectable or operator-selected. Alternatively, the transmission 48 may be a continuously-variable transmission (CVT) that employs a variator that is controllable to a speed ratio of output speed to input speed, wherein the speed ratio that is infinitely variable over a predetermined range of operation. CVTs are known and not described in further detail herein. The transmission 48 may include a mechanically-driven hydraulic pump, a hydraulic circuit, a clutch assembly, and other torque transfer elements including, by way of non-limiting examples, planetary gear sets, clutches, brakes, and the like. A transmission controller (TCM) 57 monitors rotational speeds of various rotating members and controls operation of various controllable components, including the clutches of the transmission 48 and a torque converter clutch of the torque converter 46. The TCM 57 includes executable code to control the transmission 48 to a preferred state in response to operating conditions. The preferred state may be a selected transmission gear and associated gear ratio when the transmission 48 is a step-gear transmission. The preferred state may be a selected transmission speed ratio when the transmission 48 is a CVT.

The first torque machine 36 may be any suitable non-combustion torque machine, and is a high-voltage multi-phase electric motor/generator in one embodiment, and as shown. The first torque machine 36 includes the rotor and a stator, and electrically connects to a high-voltage DC power source (battery) 25 via a first inverter circuit 35 and a high-voltage DC bus 29. Other torque machines may include, by way of non-limiting examples, a pneumatically-powered torque machine or a hydraulically-powered torque machine. Pneumatically-powered torque machines and hydraulically-powered torque machines are known to those skilled in the art, and not described in detail herein. The first torque machine 36 is configured to convert stored electric energy to mechanical power and convert mechanical power to electric energy that may be stored in the battery 25. The battery 25 may be any high-voltage DC power source, e.g., a multi-cell lithium ion device, an ultracapacitor, or another suitable device without limitation. In one embodiment, the battery 25 may electrically connect via an on-vehicle battery charger 24 to a remote, off-vehicle electric power source for charging while the vehicle 100 is stationary. The battery 25 electrically connects to the first inverter module 35 via the high-voltage DC bus 29.

The first inverter module 35 is configured with suitable control circuits including power transistors, e.g., IGBTs for transforming high-voltage DC electric power to high-voltage AC electric power and transforming high-voltage AC electric power to high-voltage DC electric power. The first inverter module 35 is controlled to transfer high-voltage DC electric power to the first torque machine 36 in response to control signals originating in the control system 10. The first inverter module 35 preferably employs pulsewidth-modulating (PWM) control to convert stored DC electric power originating in the high-voltage battery 25 to AC electric power to drive the first torque machine 36 to generate torque. Similarly, the first inverter module 35 converts mechanical power transferred to the first torque machine 36 to DC electric power to generate electric energy that is storable in the battery 25, including as part of a regenerative power control strategy. The first inverter module 35 is configured to receive motor control commands and control inverter states to provide the motor drive and regenerative braking functionality.

The second torque machine 34 and second inverter module 33 may be analogous devices to the first torque machine 36 and the first inverter module 35, respectively, although they may be suitably sized at different torque and power ratings.

In one embodiment, a DC/DC electric power converter 23 electrically connects to a low-voltage bus 28 and a low-voltage battery 27, and electrically connects to the high-voltage DC bus 29. Such electric power connections are known and not described in detail. The low-voltage battery 27 electrically connects to an auxiliary power system 26 to provide low-voltage electric power to low-voltage systems on the vehicle, including, e.g., electric windows, HVAC fans, seats, and the low-voltage solenoid-actuated electrical starter.

The driveline 60 may include a differential gear device 65 that mechanically couples to an axle, transaxle or half-shaft 64 that mechanically couples to the first wheels 66 that interact with a road surface in one embodiment. The driveline 60 transfers propulsion torque between the gear train 50 and the first drive wheels 66 to the road surface.

An operator interface 14 of the vehicle 100 includes a controller that signally connects to a plurality of human/machine interface devices through which the vehicle operator commands operation of the vehicle 100. The human/machine interface devices include, e.g., an accelerator pedal 15, a brake pedal 16, and a transmission range selector 17. Other human/machine interface devices preferably include an ignition switch to enable an operator to crank and start the engine 40, a steering wheel, and a headlamp switch. The accelerator pedal 15 provides signal input indicating an accelerator pedal position (PPS) and the brake pedal 16 provides signal input indicating a brake pedal position (BPS). The transmission range selector 17 provides signal input indicating direction of operator-intended motion of the vehicle (PRNDL) including a discrete number of operator-selectable positions indicating the preferred rotational direction of the output member 62 in either a forward direction, a reverse direction, or neutral. An output speed sensor 61 is employed to monitor rotational speed of the output member 62, and may be any suitable device, e.g., a Hall effect sensor. Signal output from the output speed sensor 61 may be employed to determine a rotational speed of the drive wheel 66, and thus determine a vehicle speed based thereon.

The control system 10 includes controller 12 that signally connects to the operator interface 14. The controller 12 is depicted as a single device for ease of illustration, but may be composed from a plurality of discrete devices that are co-located with the individual elements of the powertrain system 20 to effect operational control of the individual elements of the powertrain system 20 in response to operator commands and powertrain demands. The controller 12 may also include a control device that provides hierarchical control of other control devices. The controller 12 communicatively connects to each of the high-voltage battery 25, the first inverter module 35, the ECM 45 and the TCM 57, either directly or via a communications bus 18 to monitor and control operation thereof.

The controller 12 commands operation of the powertrain system 20, including selecting and commanding operation in one of a plurality of operating modes to generate and transfer torque between the torque generative devices, e.g., the engine 40, the first torque machine 36, the second torque machine 34 when employed, and the first and second drive wheels 66, 68, in response to traction power commands, engine power commands and motor power commands.

The terms controller, control module, module, control, control unit, processor and similar terms refer to any one or various combinations of Application Specific Integrated Circuit(s) (ASIC), electronic circuit(s), central processing unit(s), e.g., microprocessor(s) and associated non-transitory memory component in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean any controller-executable instruction sets including calibrations and look-up tables. Each controller executes control routine(s) to provide desired functions, including monitoring inputs from sensing devices and other networked controllers and executing control and diagnostic instructions to control operation of actuators. Routines may be executed at regular intervals, for example each 100 microseconds during ongoing operation. Alternatively, routines may be executed in response to occurrence of a triggering event. Communication between controllers, and communication between controllers, actuators and/or sensors may be accomplished using a direct wired point-to-point link, a networked communication bus link, e.g., bus 18, a wireless link or any other suitable communication link. Communication includes exchanging data signals in any suitable form, including, for example, electrical signals via a conductive medium, electromagnetic signals via air, optical signals via optical waveguides, and the like. The data signals may include discrete, analog or digitized analog signals representing inputs from sensors, actuator commands, and communication between controllers. The term “signal” refers to any physically discernible indicator that conveys information, and may be any suitable waveform (e.g., electrical, optical, magnetic, mechanical or electromagnetic), such as DC, AC, sinusoidal-wave, triangular-wave, square-wave, vibration, and the like, that is capable of traveling through a medium. The term ‘model’ refers to a processor-based or processor-executable code and associated calibration that simulates a physical existence of a device or a physical process.

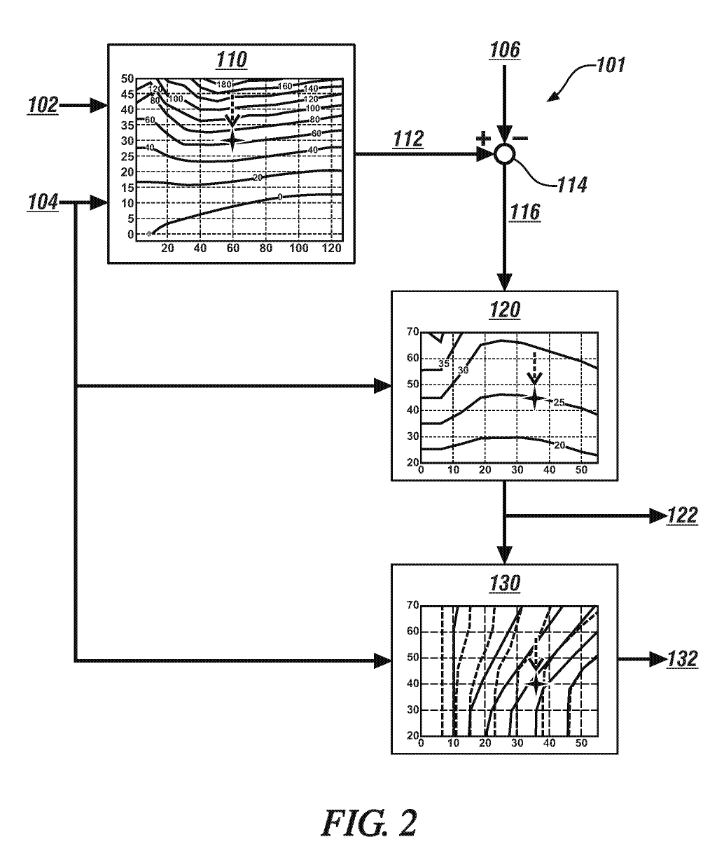

FIG. 2 schematically shows a control routine 101 for controlling an embodiment of the powertrain system 100 described with reference to FIG. 1 to select a preferred transmission gear 132, and the transmission 48 is commanded to operate at the preferred transmission gear 132. One skilled in the art appreciates that the concepts described herein may be advantageously employed on various parallel-hybrid powertrain systems that include an internal combustion engine and a transmission that are arranged in a parallel configuration with a non-combustion torque machine to generate and transfer traction power to a driveline for vehicle propulsion. Regularly monitored parameters include vehicle speed (VSS) 102, an operator input to an accelerator pedal, preferably in the form of accelerator pedal position (PPS) 104, and a motor power 106 that is input from the first torque machine 36. The motor power 106 may be estimated, monitored, or otherwise determined. Due to the responsive operation of torque machines, the motor power 106 represents both an achieved motor power and a commanded motor power, as appreciated by those skilled in the art.

The motor power 106 may be associated with operating the first and/or second torque machine 36, 34 as a torque motor to provide positive motor power to the gear train 50, i.e., discharging, which increases the traction power from the powertrain system 100 in response to an acceleration command. The motor power 106 may be associated with operating the either the first and/or second torque machine 36, 34 as a generator to provide negative motor power, i.e., charging, to the gear train 50, wherein negative motor power is employed to generate electric power that may be stored on the battery 25. Negative motor power, i.e., charging may be commanded in response to a demand to increase a state of charge (SOC) of the battery 25, or in response to a deceleration command, such as either coasting or braking. As such, negative motor power may be associated with increased regenerative braking power and decreased traction power from the powertrain system 100. A traction power command 112 from the powertrain system 100 to the driveline 60 is determined based upon VSS 102 and the PPS 104, with power contributed from either or both the engine 40 and the first torque machine 36. When the SOC of the battery 25 is greater than an upper threshold SOC, the controller 12 may choose to employ the first torque machine 36 to contribute additional traction power to reduce the SOC. When the SOC of the battery 25 is less than a lower threshold SOC, the controller 12 may choose to employ the first torque machine 36 to generate additional electric energy to increase the SOC, regardless of the vehicle speed and the total traction power.

The VSS 102 and the PPS 104 are periodically provided to a pedal map 110 to determine the traction power command 112. The traction power command 112 may be employed to determine an initial engine power command, which is a magnitude of engine power that is required to operate the powertrain system 100 in response to the VSS 102 and the PPS 104 when all of the traction power is originating from the engine 40 and the motor power 106 that is input from the first torque machine 36 is zero. As appreciated by one skilled in the art, the engine power output values including the initial engine power command may instead be referred to as a torque command, a throttle command or another suitable related term.

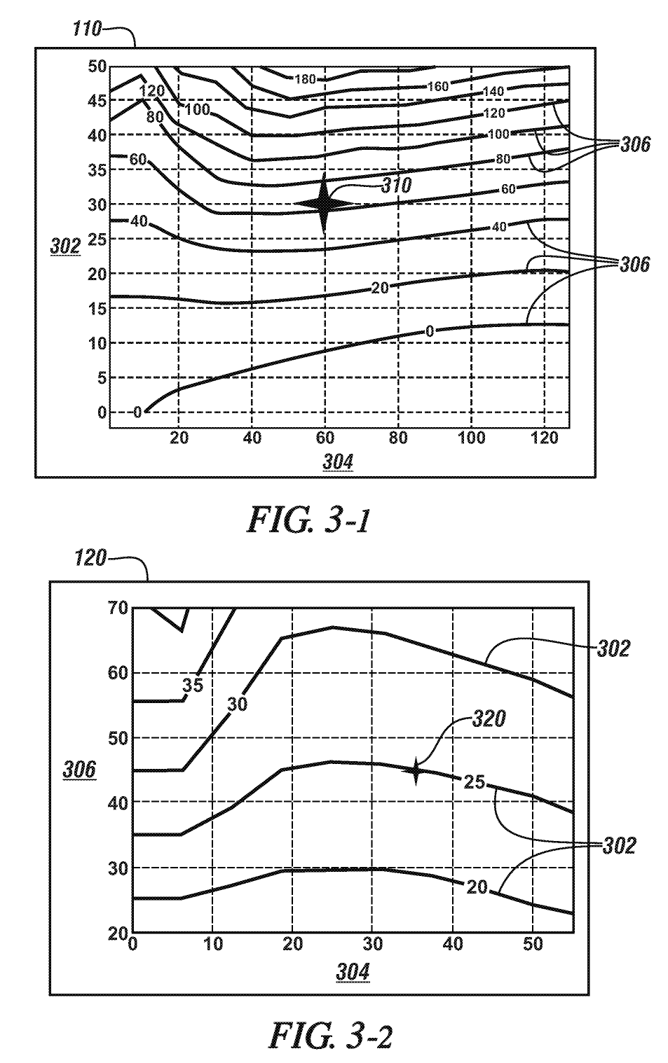

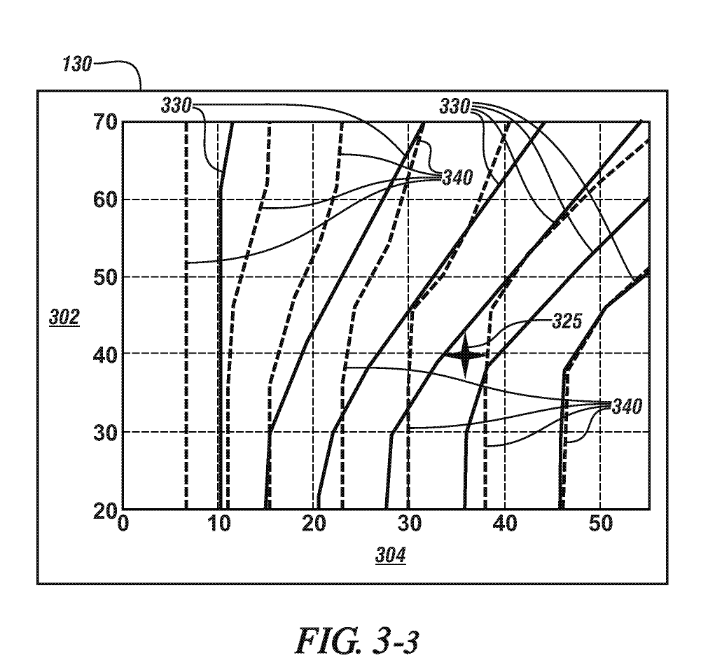

FIG. 3-1 graphically shows one embodiment of the pedal map 110 described with reference to FIG. 2, and includes initial engine power output values that are required to operate an embodiment of the powertrain system 100, plotted in relation to the vehicle speed (VSS) 304 in kilometers per hour (kph), shown on the horizontal axis, and accelerator pedal position (APP) 302, in percentage (%) of a wide-open throttle value, which is shown on the vertical axis, when all of the traction power is originating from the engine 40. A plurality of iso-engine power output lines 306 are shown, including engine power magnitudes of 0 kW, 20 kW, 40 kW, etc. The pedal map 110 is advantageously employed to determine a magnitude for the initial engine power output that may be commanded in response to a magnitude of the VSS 304 and a magnitude of the APP 302. The pedal map 110 may be determined during powertrain development, and reduced to practice as an array of initial engine power outputs that is stored in a non-volatile memory device and is searchable based upon the VSS 304 and the APP 302. An example operating point 310 is shown for purposes of illustration, and includes an engine operating point of about 65 kW that is associated with VSS=60 kph and APP=30%. Pedal maps are specific to an embodiment of a powertrain system, and processes related to their development and implementation are known to those skilled in the art.

Referring again to the control routine 101 described with reference to FIG. 2, an adjusted engine power command 116 is determined via a difference operator 114 by reducing the traction power command 112 by the magnitude of the motor power 106 that is input from the first torque machine 36.

The adjusted engine power command 116 and the VSS 102 are provided to an inverse pedal map 120 to determine an adjusted accelerator pedal position (PPS*) 122. FIG. 3-2 graphically shows one embodiment of a portion of an inverse pedal map 120 described with reference to FIG. 2. The inverse pedal map 120 includes a plurality of APP values, in percentage (%) of a wide-open throttle value for an embodiment of the engine 20 of the powertrain system 100. The APP values are plotted in relation to the vehicle speed (VSS) 304 in kilometers per hour (kph), shown on the horizontal axis and engine power output 306, in kilowatts, which is shown on the vertical axis. A plurality of iso-APP lines 302 are shown, including APP values of 20%, 25%, 30%, etc. The inverse pedal map 120 is advantageously employed to determine a magnitude for the APP 302 that is associated with a magnitude of the VSS 304 and a magnitude of the engine power output 306. The inverse pedal map 120 is an inverted form of the pedal map 110, and is developed based upon a 1:1 relationship between engine power and APP at a selected vehicle speed. Therefore, the pedal map 110 is invertible to achieve the inverted pedal map 120 at each vehicle speed. A second example operating point 320 is shown for purposes of illustration, and includes an APP of 25% that is associated with an engine operating point of about 45 kW and VSS=60 kph. The second example operating point 320 represents a magnitude for the PPS* 122 when the example operating point 310 of about 65 kW that includes a motor power contribution of 20 kW.

Referring again to the control routine 101 described with reference to FIG. 2, the PPS* 122 and the VSS 102 are provided to a transmission shift map 130 to determine a preferred transmission gear 132, and the transmission 48 is commanded to operate at the preferred transmission gear 132. FIG. 3-3 graphically shows one embodiment of a transmission shift map 130 described with reference to FIG. 2, and includes a plurality of APP values, in percentage (%) of a wide-open throttle value for an embodiment of the powertrain system 100, which is shown on the vertical axis 302 in relation to the vehicle speed (VSS) in kilometers per hour (kph), shown on the horizontal axis 304. A plurality of upshift points 330 and a plurality of downshift points 340 are indicated. A third example operating point 325 represents a preferred transmission gear that is associated with the second example operating point 320 for the magnitude for the PPS* 122 at the example operating point 310 of about 65 kW including a motor power contribution of 20 kW, i.e., at an engine operating point of 45 kW and a vehicle speed of VSS=60 kph. Transmission shift maps are specific to an embodiment of a powertrain system, and processes related to their development and implementation are known to those skilled in the art.

Referring again to the control routine 101 described with reference to FIG. 2, the second example operating point 210 represents the adjusted accelerator pedal position (PPS*) 122, which is a magnitude of the APP that is associated with operating the internal combustion engine 20 when the first torque machine 36 is contributing to the driveline torque. Operation of the powertrain system 20 is implemented, including controlling the transmission 48 to the preferred transmission gear 132, which is selected as described herein, and controlling the internal combustion engine responsive to the adjusted accelerator pedal position (PPS*) 122.

The concepts described herein facilitate optimization of selection of a gear state for a parallel hybrid powertrain architectures that employs the same shift schedule and pedal map as a non-hybrid powertrain architecture. This reduces development effort, and permits optimization of operation for fuel economy with minimal changes in control routine while maintaining drivability.

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation. Furthermore, in reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A method for controlling a hybrid powertrain system employed on a vehicle, wherein the hybrid powertrain system includes an internal combustion engine and a transmission arranged in a parallel configuration with a non-combustion torque machine to transfer traction power to a driveline of the vehicle, the method comprising:
monitoring vehicle speed and an accelerator pedal position;
determining a traction power command based upon the vehicle speed and the accelerator pedal position;
determining a motor power that is input to the driveline from the torque machine;
determining an adjusted engine power command that is transferable to the transmission based upon the traction power command and the motor power from the torque machine;
determining an adjusted accelerator pedal position based upon the adjusted engine power command and the vehicle speed;
determining a preferred transmission state based upon the adjusted accelerator pedal position and the vehicle speed; and
controlling the transmission to the preferred transmission state.

2. The method of claim 1, further comprising controlling the internal combustion engine responsive to the adjusted engine power command.

3. The method of claim 1, further comprising controlling the torque machine responsive to the motor power.

4. The method of claim 1, wherein the traction power command comprises an initial engine power command for operating the powertrain system responsive to the vehicle speed and the accelerator pedal position when all of the traction power originates from the engine.

5. The method of claim 4, wherein the initial engine power command comprises a torque command.

6. The method of claim 1, wherein the motor power that is input from the torque machine comprises a positive value that is associated with discharging stored energy.

7. The method of claim 1, wherein the motor power that is input from the torque machine comprises a negative value that is associated with charging energy.

8. The method of claim 1, comprising determining the adjusted engine power command that is transferable to the transmission based upon a difference between the traction power command and the motor power from the torque machine.

9. The method of claim 1, further comprising employing an inverted pedal map to determine the adjusted accelerator pedal position based upon the adjusted engine power command and the vehicle speed.

10. The method of claim 1, wherein determining a preferred transmission gear based upon the adjusted accelerator pedal position and the vehicle speed comprises selecting the preferred transmission gear from a transmission shift map.

11. A method for controlling a hybrid powertrain system including an internal combustion engine rotatably coupled to a transmission and arranged in a parallel configuration with a non-combustion torque machine to transfer traction power to an output member, the method comprising:
monitoring rotational speed of the output member and an accelerator pedal position;
determining a traction power command based upon the rotational speed of the output member and the accelerator pedal position;
determining an initial engine power command based upon the traction power command;
determining a motor power that is input from the torque machine;
determining an adjusted engine power command based upon the initial engine power command and the motor power from the torque machine;
determining an adjusted accelerator pedal position based upon the adjusted engine power command and the vehicle speed;
determining a preferred transmission gear based upon the adjusted accelerator pedal position and the vehicle speed;
controlling the transmission to the preferred transmission gear;
controlling the internal combustion engine responsive to the adjusted engine power command; and
controlling the torque machine responsive to the motor power.

12. A hybrid powertrain system for a vehicle, comprising:
an internal combustion engine rotatably coupled to a transmission and arranged in a parallel configuration with a non-combustion torque machine to transfer traction power via a gear set to a driveline;
a controller operatively connected to the internal combustion engine, the transmission and the non-combustion torque machine, the controller including an instruction set, the instruction set executable to:
monitor vehicle speed and an accelerator pedal position;
determine a traction power command based upon the vehicle speed and the accelerator pedal position;
determine a power input from the torque machine;
determine an adjusted engine power command that is transferable to the transmission based upon the traction power command and the power input from the torque machine;
determine an adjusted accelerator pedal position based upon the adjusted engine power command and the vehicle speed;
determine a preferred transmission state based upon the adjusted accelerator pedal position and the vehicle speed; and
control the transmission to the preferred transmission state.

13. The hybrid powertrain system of claim 12, wherein the transmission comprises a step-gear transmission.

14. The hybrid powertrain system of claim 12, wherein the transmission comprises a continuously variable transmission.

15. The hybrid powertrain system of claim 12, wherein the non-combustion torque machine torque machine comprises an electric motor/generator; and further comprising a high-voltage DC power source electrically connected to the electric motor/generator via an inverter circuit.

16. The hybrid powertrain system of claim 12, wherein the non-combustion torque machine torque machine comprises pneumatically-powered torque machine.

17. The hybrid powertrain system of claim 12, wherein the non-combustion torque machine torque machine comprises a hydraulically-powered torque machine.

18. The hybrid powertrain system of claim 12, wherein the instruction set is executable to determine the adjusted accelerator pedal position employing an inverted pedal map based upon the engine power command and the vehicle speed.

19. The hybrid powertrain system of claim 12, wherein the instruction set is executable to determine the adjusted engine power command that is transferable to the transmission based upon a difference between the traction power command and the motor power from the torque machine.

20. The hybrid powertrain system of claim 12, wherein the instruction set is executable to select the preferred transmission gear from a transmission shift map based upon the adjusted accelerator pedal position and the vehicle speed.
